(19) United States
(12) Patent Application Publication
(10) Pub. No.: US 2026/0151711 A1
(43) Pub. Date: Jun. 4, 2026

(54) SYSTEM AND METHOD FOR ACTUATING RIDE COMPONENTS BASED ON CONTOURS OF FLUID

(71) Applicant: Universal City Studios LLC, Universal City, CA (US)

(72) Inventor: Jacob David Allinson, Orlando, FL (US)

(21) Appl. No.: 19/360,606

(22) Filed: Oct. 16, 2025

Related U.S. Application Data
(60) Provisional application No. 63/727,387, filed on Dec. 3, 2024.

(51) Int. Cl. A63G 31/06; A63G 31/00; G06V 10/46; G06V 10/48

(52) U.S. Cl. CPC A63G 31/06; A63G 31/007; G06V 10/46; G06V 10/48

(57) ABSTRACT

A method of operating an amusement park ride includes emitting a fluid, detecting a shape of a contour of the fluid, mapping the shape of the contour of the fluid into three-dimensional space, and raising or lowering a ride vehicle based on the shape of the contour of the fluid in the three-dimensional space at a particular location.

### CROSS-REFERENCE TO RELATED APPLICATION

This application claims priority from and the benefit of U.S. Provisional Patent Application No. 63/727,387, entitled “SYSTEM AND METHOD FOR ACTUATING RIDE COMPONENTS BASED ON CONTOURS OF FLUID”, filed Dec. 3, 2024, which is hereby incorporated by reference in its entirety for all purposes.

### BACKGROUND

The present disclosure relates generally to amusement park rides, and more specifically to creating the impression that components of amusement park rides are floating on or in fluid.

Fluid dynamics are complex and difficult to model. Accordingly, for amusement park rides that involve ride vehicles and/or set pieces that appear to float on or in fluid, the pre-scripted mechanical movements of the ride vehicles and/or set pieces can diverge from the unpredictable movement of the fluid, resulting in an unrealistic experience for guests. Accordingly, new techniques for actuating ride vehicles and/or set pieces that appear to float on or in fluid are needed in order to improve guest experiences.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In an embodiment, a ride system includes a fluid source, a sensor, a computing device, and a motion system. The fluid source is configured to emit fluid. The sensor is configured to detect a shape of a contour of the fluid and output data indicative of the shape of the contour of the fluid. The computing device includes processing circuitry and memory, accessible by the processing circuitry, the memory storing instructions that are executable by the processing circuitry. The instructions define operations to receive the data indicative of the shape of the contour of the fluid from the sensor, map the data indicative of the shape of the contour of the fluid into three-dimensional space, and generate a command to raise or lower a ride vehicle based on the shape of the contour of the fluid in the three-dimensional space at a particular location. The motion system receives the command from the computing device and raises or lowers the ride vehicle based on the command.

In an embodiment, a method of operating an amusement park ride includes emitting a fluid, detecting a shape of a contour of the fluid, mapping the shape of the contour of the fluid into three-dimensional space, and raising or lowering a ride vehicle based on the shape of the contour of the fluid in the three-dimensional space at a particular location.

In an embodiment, a non-transitory computer readable medium stores instructions that, when executed by processing circuitry, cause the processing circuitry to receive data indicative of a shape of a contour of a body of liquid or gaseous fluid from a sensor, map the data indicative of the shape of the contour of the body of fluid into three-dimensional space, generate a set of coordinates for the body of fluid in the three-dimensional space, generate a command to raise or lower a ride vehicle based on the shape of the contour of the body of fluid in the three-dimensional space at a particular location; and output the command to a motion system.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of a ride being used in an amusement park, in accordance with an embodiment of the present disclosure;

FIG. 2 is a schematic of the ride of FIG. 1, in accordance with an embodiment of the present disclosure;

FIG. 3 is a block diagram of example components of a computing device that could be used in the ride of FIGS. 1 and 2, or some other device of FIGS. 1 and 2, in accordance with an embodiment of the present disclosure; and

FIG. 4 is a flowchart of a process for actuating components of the ride of FIGS. 1 and 2 based on contours of fluid, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments.

The present disclosure is directed to techniques for operating an amusement park ride such that a ride vehicle and/or a set piece appear to be floating in or on a fluid (e.g., gas, vapor, aerosol, smoke, particulate matter suspended in gas, liquid). The presently disclosed techniques may be applied to gaseous or liquid fluid. For example, present embodiment may coordinate with a body of liquid fluid (e.g., to imitate floating on the liquid without actually contacting the liquid or relying on the liquid for floatation).

In one embodiment, a fluid source (e.g., a fog machine, a smoke machine, pump, fan, or other source of fluid), emits a cloud of gaseous fluid, such as vapor, fog, smoke, aerosol, particulate matter suspended in fluid, etc. Further, a lighting system may be used to make the fluid appear to be of a certain color, or to create visual effects like lightning, currents, and/or supernatural events. A fluid manipulator, such as a fan, a parachute, sail, or other sheet of material may be configured to interact with an airflow or a structural member (e.g., an airfoil) to facilitate shaping of the fluid. The fluid manipulator may be configured to actuate (e.g., translate, rotate, spin, swing) in a way that changes the shape of the fluid (e.g., by creating a wave or a bank). One or more sensors may detect a shape of a contour of the fluid and output data indicative of the shape of the contour of the fluid. For example, the sensors may detect when measured values (e.g., visibility, reflectivity, density, concentration, etc.) of the fluid cross one or more threshold values. The sensors may include, for example, computer vision systems, imaging sensors, infrared sensors, fluid level sensors, an array of lasers, and so forth. Further, multiple sensors may be disposed about the fluid to take measurements from the fluid from different vantage points. A controller (e.g., a processor-based computing device) may receive the data from the one or more sensors and map the shape of the contour of the fluid into three-dimensional space (e.g., by applying a mapping routine). This may include mapping an undulating surface (e.g., upper surface or boundary) of the fluid. The controller may then generate a command to actuate a ride vehicle and/or one or more set pieces to create the appearance that the ride vehicle and/or the one or more set pieces are floating in or on the surface of the fluid (e.g., on an undulating upper surface of the fluid). For example, the controller may generate a command to raise or lower the ride vehicle and/or the one or more set pieces based on the height of the contour of the fluid such that the ride vehicle and/or the one or more set pieces appear to be floating in or on the surface of the fluid. The controller may output the commands to one or more motion systems, which actuate the ride vehicle and/or the one or more set pieces based on the commands. In some embodiments, the one or more motion systems may be configured to actuate the ride vehicle and/or the one or more set pieces in a single vertical direction (e.g., raise and lower). In some embodiments, the one or more motion systems may be configured to translate the ride vehicle and/or the one or more set pieces in a horizontal plane (e.g., one or both horizontal directions). Further, in some embodiments, the one or more motion systems may be configured to rotate the ride vehicle and/or the one or more set pieces about one, two, or three axes (e.g., roll, pitch, and yaw), which may be used to create the appearance that the ride vehicle and/or the one or more set pieces are tilting in response to interaction with the fluid. As the shape of the contour of the fluid changes, the sensors may provide additional data to the controller, such that the controller generates new commands for the one or more motion systems to actuate the ride vehicle and/or the one or more set pieces in response to the changing shape of the contour of the fluid. Accordingly, presently disclosed embodiments may create the appearance that the ride vehicle and/or the one or more set pieces are interacting with the gaseous or liquid fluid. This may create a realistic experience for the guest, thus improving the guest experience and the guest's satisfaction.

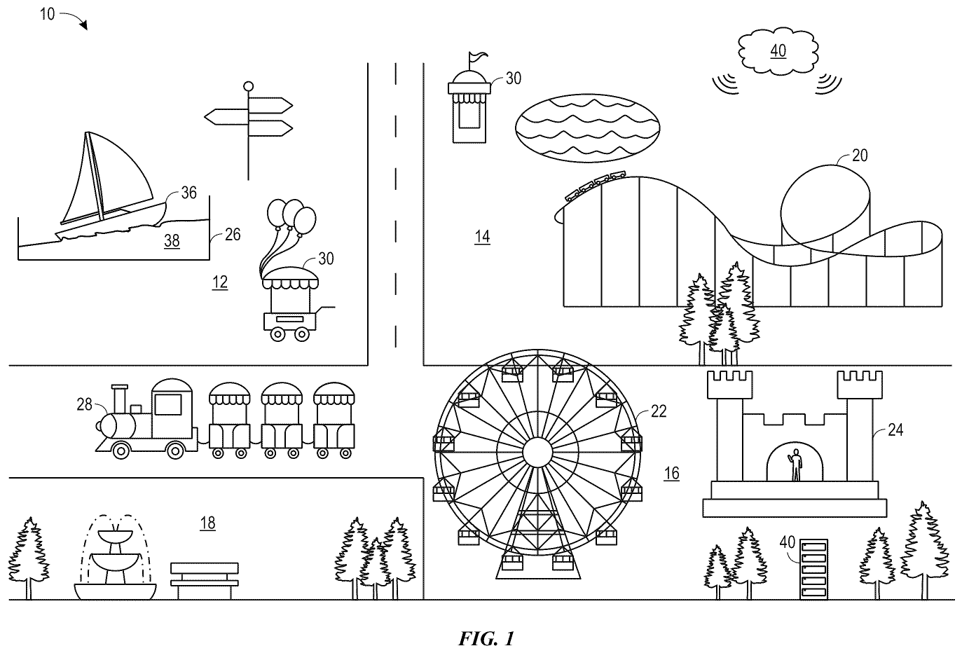

FIG. 1 is a schematic of an amusement park 10. The amusement park 10 may include and/or be separated into one or more sections or lands, such as a first land 12, a second land 14, a third land 16, and a fourth land 18. Each of the lands 12, 14, 16, 18 may include one or more attractions. As shown in FIG. 1, the attractions may include roller coasters 20, carousels 22, or attractions in which a guest is moved through an environment, environments through which guests walk, such as castles 24, rides 26, and so forth. The amusement park 10 may also include transportation 28, such as trams, trains, trolleys, and so forth that are configured to move guests within or between lands 12, 14, 16, 18 of the amusement park 10. Further, the amusement park 10 may include one or more vending locations 30. The vending locations 30 may be stationary (e.g., a storefront), mobile (e.g., a cart), or semi-mobile (e.g., a stand), and configured to sell items, such as food, merchandise, toys, souvenirs, toiletries, and so forth to guests.

Some of the rides 26 may create the experience of a ride vehicle 36 floating on or within a body of fluid 38. For example, the ride 26 may simulate a boat 36 floating on a body of water or other liquid fluid. In some embodiments, the ride 26 may simulate a ride vehicle 36 floating on a body of gaseous fluid 38, smoke, haze, or some other gaseous fluid. Movement of the ride vehicle 36, such as via actuators coupled to the ride vehicle 36, may be controlled to correspond with the changing surface contours of the fluid 38. This coordination of movement with the contours of the fluid 38 may cause guests on the ride vehicle 36 to feel as though the ride vehicle 36 is floating on or within the fluid 38. However, complex fluid dynamics can make it difficult to generate predictable movement of the fluid 38 (e.g., within a body of fluid), such that pre-scripted movement of the ride vehicle 36 can diverge from movement of the fluid 38, resulting in unrealistic guest experiences. Accordingly, the present disclosure is directed to a ride 26 in which sensors are used to determine the contours of the body of fluid 38 (e.g., via one or more servers 40) and then motion of the ride vehicle 36 and/or one or more set pieces are controlled (e.g., via the one or more servers 40), based on the determined contour of the fluid.

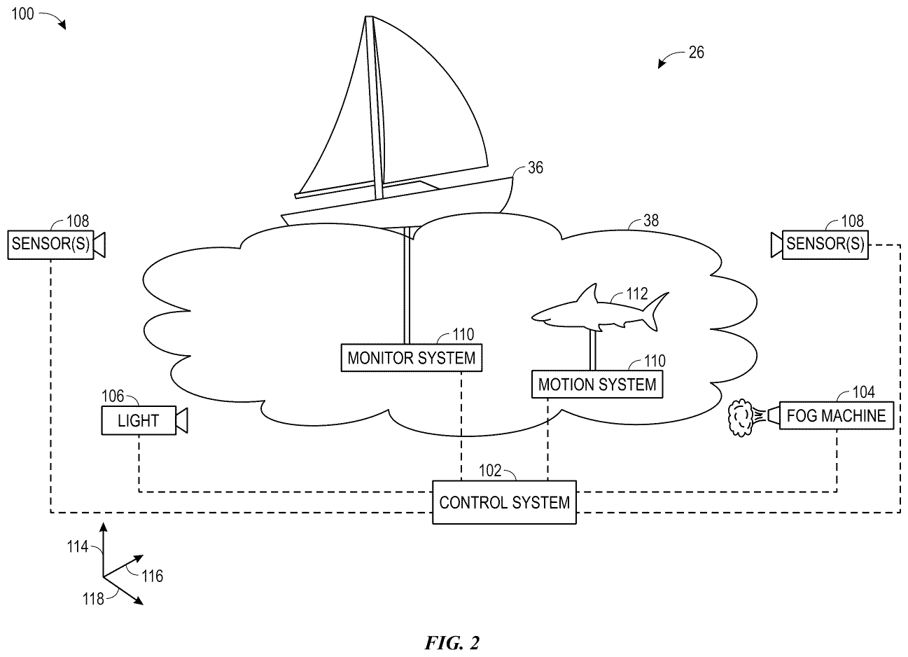

FIG. 2 is a schematic of a ride system 100 for the ride 26 shown in FIG. 1. As shown, the ride system 100 includes a control system 102, a fog machine 104 (or other fluid emitting device), a lighting system 106, one or more sensors 108, one or more motion systems 110, a ride vehicle 36 and one or more show pieces 112. It should be understood, however, that the embodiment shown in FIG. 2 is merely an example for purposes of illustration and that other embodiments are envisaged having more components, fewer components, and/or different combinations of components. Accordingly, the disclosed techniques are not intended to be limited to the specific combination of components shown in FIG. 2.

The fluid source (e.g., fog machine 104) may be a special effects fog machine or some other device (e.g., a fluid emitter) configured to generate a cloud of fluid 38, fog, vapor, smoke, haze, aerosol, particulate matter suspended in a gaseous fluid, or other distributed particles. Accordingly, the fog machine 104 may be configured to generate fog, smoke, haze, or other visible gaseous fluid from one or more liquid fluids. For example, the fog machine 104 may be configured to generate a cloud of water vapor using water as an input fluid. In some embodiments, additives, such as glycerin or glycol, may be added to the fluid in order to produce denser, more opaque smoke or fog. In other embodiments, one or more other fluids may be used by the fog machine 104 to generate fog or smoke. In some embodiments, one or more fluids may be a solution or mixture that includes particles of other materials (e.g. metals, ceramics, etc.) that may make the fluid easier to detect via the sensors 108 and/or make the fluid more visible to guests. In some embodiments, the fluid source may be a pump, a hose, or other source of liquid fluid). Further, in some embodiments, the fluid may be heated or cooled in order to make the fluid easier to detect via the sensors 108, make the fluid more visible to guests, and/or to make the fluid have different characteristics (e.g., dissipate slower or faster, stay in place, etc.). Accordingly, the fog machine 104 may include heating and/or cooling elements for heating and/or cooling the fluid. Further, the fluid source 104 may be connected to an input line of the one or more fluids or may include one or more reservoirs for the one or more fluids or substances (e.g., a primary fluid and one or more additives). The fog machine 104 may be controlled by the control system 102 to emit fluid continuously, periodically, according to a schedule, based on sensor data related to the size, shape, and/or contours of the fluid, based on received inputs (e.g., an operator pushing a button, a command received from another device, etc.), in response to some condition being met, and so forth. Though not shown, in some embodiments, the ride system 100 may include one or more components to modify or shape the fluid 38. The components may include, for example, a fan, a parachute, sail, or other sheet of material configured to interact with airflow, an airfoil or other structural member configured to be actuated (e.g., translated, rotated, spun, swung, etc.) in a way that changes the shape of the fluid (e.g., by creating a wave or a bank), and so forth.

Though FIG. 2 illustrates an embodiment in which the fluid 38 is made of a fluid in gaseous form, it should be understood that the disclosed techniques may also be used in rides 26 that utilize fluids in liquid form. That is, embodiments are envisaged in which ride vehicle 36 and/or the one or more set pieces 112 are actuated to appear to float on or in a body of liquid fluid.

In some embodiments, the lighting system 106 may include one or more lights or lasers configured to emit or otherwise direct light into the fluid. The light may be a constant light, or light of high enough frequency to appear constant, in order to make the fluid appear to be of a certain color. For example, the light may be blue to make the fluid 34 appear as part of the ocean, or the light may be orange to make the fluid appear as lava from a volcano. In other embodiments, the lighting system 106 may flash or shoot lasers to simulate lightning, magic spells, or other supernatural events, and so forth.

The one or more one or more sensors 108 may be used to detect the location, size, shape, and contours of the fluid 38. As shown, the ride system 100 may include multiple sensors 108 in order to triangulate the location and/or contours of the fluid 38. The sensors 108 may include computer vision sensors (e.g., sensors that use cameras and computer-based image processing to capture and analyze visual data to identify patterns, shapes, colors, and textures, or perform tasks such as object detection, positioning, measurement, and inspection), cameras, other imaging sensors, fluid level sensors, an array of lasers used to determine where the fluid is, infrared sensors, RADAR, light detection sensors, proximity sensors, chemical sensors, or any combination thereof to detect the location, shape, and contour of the fog. In some embodiments, the sensors 108 may be a combination of different types of sensors. The sensors 108 may generate sensor data representative of the presence, position, and/or contours of the boundary of the fluid 38 (e.g., where some value crosses a threshold, defining the edge of the fluid) and pass the sensor data to the control system 102 for processing.

For example, if the sensors 108 include one or more computer vision sensors, cameras, or other imaging sensors, the sensors 108 may be configured to identify the presence of the body of gaseous and/or liquid fluid 38 in still images and/or frames of a video. The sensors (e.g., one or more computer vision sensors) may be able to identify an edge or boundary of the fluid 38 based on when the fluid 38 goes from visible to not visible, or crosses some threshold of visibility, reflectivity, density, concentration, or some other measured value. In some embodiments, the sensor 108 may be able to fit shapes (e.g., bounding boxes), curves, or lines to the edge of the fluid 38 to identify and model the shape of the contours of the boundary of the fluid 38. If the location of the sensor 108 (e.g., computer vision sensor) and/or the direction the sensor 108 is pointing are known, the sensor 108 may be able to identify characteristics of the location of the boundary of the fluid 38. If there are multiple sensors 108 in different locations facing the same body of fluid 38, data from the different sensors 108 may be stitched together (e.g., triangulated) to identify the location and/or contours of the boundary of the body of fluid 38 in three-dimensional space. Further, by monitoring the body of fluid 38 over the course of multiple frames, the sensor 108 (e.g., computer vision sensor) may be able to identify how the boundary of the body of fluid 38 is changing over time.

If the sensors 108 include one or more infrared sensors, the fluid 38 may be heated or cooled prior to being emitted by the fog machine 104 such that the fluid appears hotter or cooler to an infrared sensor. However, in some embodiments, the fluid 38 may not be heated or cooled. Accordingly, the boundary of the fluid 38 as determined by the infrared sensor may be the point at which a temperature threshold is crossed, or the point at which the fluid is sufficiently distinct from the surrounding air (e.g., based on some measured value). Further, in some embodiments, the fluid may be mixed with an additive (e.g., a particulate matter, an additional fluid, etc.) configured to dissipate or absorb heat such that the fluid is a different temperature from the surrounding air or is otherwise visible to an infrared camera or imaging device. As with the computer vision sensor, if the location of the infrared sensor 108 and/or the direction the sensor 108 is pointing are known, the sensor 108 may be able to identify characteristics of the location of the boundary of the fluid 38. If there are multiple infrared sensors 108 in different locations facing the same body of fluid 38, data from the different sensors 108 may be stitched together (e.g., triangulated) to identify the location and/or contours of the boundary of the body of fluid 38 in three-dimensional space. Further, by monitoring the body of fluid 38 over time, the infrared sensor 108 may be able to identify how the boundary of the body of fluid 38 is changing over time.

If the sensor 108 is a fluid level sensor, the sensor may include a component (e.g., bobber) that floats on the surface of the fluid such that the sensor 108 is able to determine the height of the level of fluid (e.g., liquid fluid) at a particular location. In some embodiments, the fluid level sensor may be fixed in place and output an indication of whether or not the fluid level sensor is submerged in fluid at its particular location. Using multiple fluid level sensors at different locations, the contours of the surface of the body of fluid can be determined or inferred. By collecting readings over time, the fluid level sensor may be able to identify how the boundary of the body of fluid 38 is changing over time.

If the sensor 108 includes an array of lasers (e.g., emitters), each laser in the array may transmit a laser beam and output an indication of whether the fluid is at or above the level of the laser based on whether the laser beam was received by a receiver. As with the fluid level sensors, using multiple lasers at different locations enables the contours of the surface of the body of fluid to be determined or inferred. By collecting readings over time, the fluid array of lasers may be able to identify how the boundary of the body of fluid 38 is changing over time.

If the sensors 108 include chemical sensors, multiple chemical sensors may be distributed throughout a space. The chemical sensors may output some measured value, such as concentration, density, etc. The boundary of the fluid may be determined when the measured value crosses some threshold value. Accordingly, readings from chemical sensors in multiple locations may be combined to determine the boundaries of the body of fluid. By collecting readings over time, the chemical sensors may be able to identify how the boundary of the body of fluid 38 is changing over time.

The control system 102, which may run on a server, such as the server 40 of FIG. 1, combines and/or stitches together data sets from multiple sensors 108, if multiple sensors 108 are being used, and maps the received data onto a coordinate system to generate coordinates of the fluid 38, or of a boundary of the fluid 38, in three-dimensional space. The control system 102 may then send commands to the one or more motion systems 110 to control movement of the ride vehicle and/or one or more show pieces 112 such that the ride vehicle and/or show pieces 112 appear to be floating within and/or on the surface of the fluid 38. In some embodiments, mapping the fluid 38 may involve running a mapping routine. The mapping may utilize artificial intelligence (AI) and/or machine learning (ML) to map data received from the sensors 108 into three-dimensional space. Further, the mapping may involve generating and/or updating a digital twin of the fluid 38, a digital twin of the ride system 100, a digital twin that encompasses the fluid 38, the ride vehicle 36, and the show piece 112, separate digital twins for the fluid 38, the ride vehicle 36, and the show piece 112, or some combination thereof. As used herein, a digital twin is a virtual representation of a physical object, system, process, or service that is updated in real-time with data to mimic its structure, state, and behavior. A digital twin of the ride 26 or portions thereof (e.g., the ride vehicle 36) may be generated to coordinate positioning with the detected positioning of the fluid 38 (e.g., a digital twin of the fluid) to mimic floating on or in the fluid. Further, the control system 102 passes instructions to the motion system 110 to control movement of the ride vehicle 36 and/or show pieces 112 such that the ride vehicle 36 and or show pieces 112 appear to be floating within or on the surface of the fluid 38. In accordance with one embodiment, this control is performed based on the digital twin of the ride system 100.

The motion systems 110 may control movement of the ride vehicle 36 and/or the one or more show pieces 112 based on the instructions received from the control system 102. In some embodiments, the ride vehicle 36 and the one or more show pieces 112 may be controlled by a single motion system, whereas in some embodiments, the ride vehicle 36 and the one or more show pieces 112 may be controlled by multiple motion systems 110 (e.g., one motion system for the ride vehicle 36 and one or more motion systems for the one or more show pieces 112). As previously described, the motion systems 110 may control the position of the ride vehicle 36 and/or the one or more show pieces 112 along a vertical direction 114 (e.g., along a Z-axis) such that the ride vehicle 36 and/or the one or more show pieces 112 appear to be floating in or on top of the fluid 38. In such embodiments, the motion system 110 may include a single actuator (e.g., an electric motor) configured to extend and contract in a single direction. However, in some embodiments, the motion system 110 may also be able to control the position of the ride vehicle 36 and/or the one or more show pieces 112 in one or more horizontal directions 116, 118 (e.g., along an X-axis and/or a Y-axis). Further, the motion systems 110 may be able to control roll, pitch, and/or yaw of the ride vehicle 36 and/or the one or more show pieces 112 around the X, Y, and/or Z axes. The motion system may include a motion base or other system for controlling motion of an object along or about one or more axes. Accordingly, the control system 102 may control the ride vehicle 36 and/or the one or more show pieces 112 via the motion systems to simulate the ride vehicle 36 and/or the one or more show pieces 112 tilting after being hit with a wave.

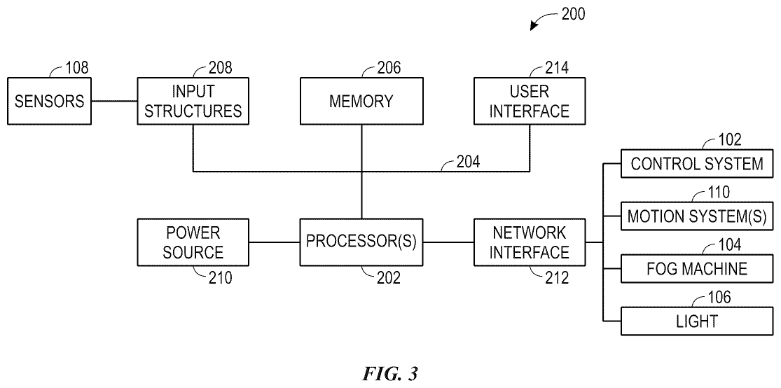

FIG. 3 illustrates a block diagram of example components of a computing device 200 that is configured to be used within the ride 26 (e.g., the ride system 100), the servers 40, or some other device within the amusement park 10 shown in FIG. 1. As used herein, a computing device 200 may be implemented as one or more computing systems including laptop, notebook, desktop, tablet, or workstation computers, as well as server type devices, network devices, such as routers, switches, edge devices, etc., internet of things (IoT) devices, microprocessors, or portable, communication type devices, such as cellular telephones and/or other suitable computing devices.

As illustrated, the computing device 200 includes various hardware components, such as one or more processors 202, one or more busses 204, memory 206, input structures 208, a power source 210, a network interface 212, a user interface 214, and/or other computer components useful in performing the functions described herein.

The one or more processors 202 (e.g., processing circuitry) may include, in certain implementations, microprocessors configured to execute instructions stored in the memory 206 or other accessible locations. Alternatively, the one or more processors 202 may be implemented as application-specific integrated circuits (ASICs), field-programmable gate arrays (FPGAs), and/or other devices designed to perform functions discussed herein in a dedicated manner. As will be appreciated, multiple processors 202 or processing components may be used to perform functions discussed herein in a distributed or parallel manner.

The memory 206 may encompass any tangible, non-transitory medium for storing data or executable routines. Although shown for convenience as a single block in FIG. 3, the memory 206 may encompass various discrete media in the same or different physical locations. For example, the memory may store code for one or more images 216 (e.g., light effects, images, animations, sprites, etc.) and/or program code to be executed by the processors 202. The one or more processors 202 (e.g., processing circuitry) may access data in the memory 206 via one or more busses 204. In some embodiments, the various components may communicate with one another wirelessly.

The input structures 208 may allow a user to input data and/or commands to the device 200 and may include mice, touchpads, touchscreens, keyboards, controllers, and so forth. As shown, the input structures may be communicatively coupled to other devices, such as the sensors 108 of FIG. 2. The power source 210 can be any suitable source for providing power to the various components of the computing device 200, including line and battery power. In the depicted example, the device 200 includes a network interface 212. Such a network interface 212 may allow communication with other devices on a network using one or more communication protocols. For example, the computing device 200 may utilize the network interface 212 to communicate with the control system 102 of FIG. 2, the one or more motion systems 110 of FIG. 2, the one or more fag machines 104 of FIG. 2, and/or the one or more lights 106 of FIG. 2. In the depicted example, the device 200 includes a user interface 214, such as a display that may display images or data provided by the one or more processors 202. The user interface 214 may include, for example, a monitor, a display, and so forth. As will be appreciated, in a real-world context, a processor-based system, such as the computing device 200 of FIG. 3, may be employed to implement some or all of the present approach, such as performing the functions of the ride 26, the servers 40, and the ride system 100 shown in FIGS. 1 and 2, as well as other memory-containing devices.

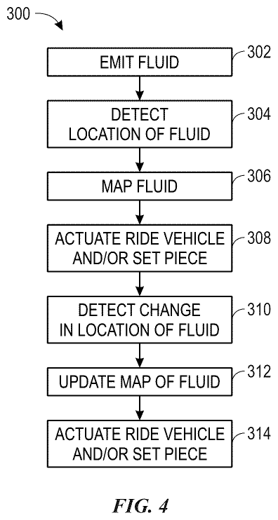

FIG. 4 is a flow chart of a process 300 for actuating components of a ride based on contours of fluid. At 302, the process 300 emits fluid. As previously described, in some embodiments, the process 300 may emit vapor, smoke, haze, or other randomly distributed particles in a gas or liquid phase. Accordingly, the fluid may be generated using water as an input fluid. The fluid emitted by the process 300 at block 302 may be water vapor or vapor of some other fluid. In some embodiments, the fluid may include one or more additives (e.g., glycerin, glycol, metals, ceramics, or other substances) that may make denser, more opaque fluid, and/or make the fluid easier to detect and/or see. In some embodiments, the fluid may be heated or cooled in order to make the fluid easier to detect, make the fluid more visible, and/or to make the fluid have different characteristics (e.g., dissipate slower or faster, stay in place, etc.). The fluid may be emitted continuously, periodically (e.g., in bursts), according to a schedule, based on sensor data related to the size, shape, and/or contours of the fluid, based on received inputs (e.g., an operator pushing a button, a command received from another device, etc.), in response to some condition being met, and so forth.

In some embodiments, the process 300 may also include manipulating fluid emitted using a fluid manipulator. For example, the fluid manipulator may include a fan, a parachute, sail, or other sheet of material configured to interact with airflow, an airfoil or other structural member configured to be actuated (e.g., translated, rotated, spun, swung, etc.) in a way that changes the shape of the fluid (e.g., by creating a wave or a bank). Further, the process 300 may include using lights to make the fluid appear to be different colors, or to create flashes simulating lightning and/or supernatural events.

At 304, the process 300 detects a location, shape, and/or contours of the fluid. As previously described, in some embodiments, the process may utilize computer vision sensors, cameras, other imaging sensors, fluid level sensors, an array of lasers used to determine where the fluid is (e.g., each laser in the array is configured to determine whether the fluid is in its path), infrared sensors, RADAR, light detection sensors, proximity sensors, chemical sensors, or any combination thereof to detect the location, shape, and contour of the fluid. In some embodiments, other sensors may be used. In some embodiments, sensors from different locations may collect data about the location, shape, and/or contours of the fluid and pass the data to a central device, such as a control system, a server, etc. for processing.

At 306, the process 300 uses the data collected from the one or more sensors to map the fluid, or contours of the fluid, into three-dimensional space. For example, the process 300 may generate a series of coordinates identifying where the fluid is, identifying a boundary of the fluid, and/or one or more contours of the fluid. If data is collected from multiple sensors at multiple locations, mapping may include stitching data together such that data from multiple two-dimensional images can be triangulated and stitched together to create data with coordinates in three dimensions. Though the detection of the fluid at block 304 may be via a visual sensor or some other type of sensor, the series of coordinates generated in block 306 may roughly correspond to a three-dimensional space in which the concentration of the fluid is assumed to be above some threshold value such that the visual characteristics of the fluid may act as a proxy for concentration. However, in some embodiments, the relationship may work in the other direction. For example, a chemical sensor may be used to detect the location of the fluid and the chemical concentration of the fluid at different data points may be used as a proxy for where the fluid would be visible to a guest.

At 308, the process 300 actuates the ride vehicle and/or one or more set pieces based on the contours of the fluid to create the appearance that the ride vehicle and/or the one or more set pieces are floating within or on top of the fluid. The coordinates of the fluid generated at block 306 represent the contours of the fluid. Accordingly, the process 300 may, via one or more motion systems, raise or lower the ride vehicle and/or the one or more set pieces to make the ride vehicle and/or one or more set pieces appear as they are floating in or on the surface of the fluid. For example, the process 300 may determine that the top of the fluid is at a particular height at a given location. Accordingly, the process may raise or lower the ride vehicle or a set piece disposed at the given location to match or be slightly below the height of the fluid to create the appearance that the ride vehicle or set piece is floating in or on the fluid. Further, the process may actuate the ride vehicle and/or one or more set pieces to translate the ride vehicle and/or one or more set pieces in a horizontal direction or rotate the ride vehicle and/or one or more set pieces about one or more axes (e.g., roll, pitch, yaw), to further create the appearance of the ride vehicle and/or set piece interacting with the fluid. For example, the process may cause the ride vehicle to rise and fall in response to waves ebbing and flowing within a body of water and then cause the ride vehicle to tilt to simulate the ride vehicle being hit by a wave.

At block 310, the process 300 may utilize the one or more sensors to detect a change in the location, shape, or contour of the fluid. This may include, for example, a shift in location of the fluid, a change in size (e.g., due to dissipation or more fluid generated) of the fluid, a change in shape of the fluid, and so forth. In some embodiments, the one or more sensors may be constantly collecting data about the location, shape, or contour of the fluid. In other embodiments, the sensors may collect periodic snapshots of data about the location, shape, or contour of the fluid (e.g., based on a schedule, receiving a request, detecting a condition being met, etc.). As previously described, if multiple sensors are being used, sensor data may be passed and aggregated by a central device, such as a control system and/or a server.

At 312, the map of the fluid may be updated based on the new data. For example, a new set of coordinates may be generated identifying where the fluid is, a shape/contour of the fluid, and/or identifying a new boundary of the fluid. At 314, the ride vehicle and/or the one or more set pieces may be actuated based on the new data. For example, contours of the fluid have changed, the location of the ride vehicle and/of set pieces may be changed based on the new shape/contour of the fluid.

The present disclosure is directed to techniques for operating an amusement park ride such that a ride vehicle and/or a set piece appear to be floating in or on a fluid (e.g., gas, vapor, aerosol, smoke, particulate matter suspended in gas, liquid). The presently disclosed techniques may be applied to gaseous or liquid fluid. For example, present embodiment may coordinate with a body of liquid fluid (e.g., to imitate floating on the liquid without actually contacting the liquid or relying on the liquid for floatation).

In one embodiment, a fluid source (e.g., a fog machine, a smoke machine, pump, fan, or other source of fluid), emits a cloud of gaseous fluid, such as vapor, fog, smoke, aerosol, particulate matter suspended in fluid, etc. Further, a lighting system may be used to make the fluid appear to be of a certain color, or to create visual effects like lightning, currents, and/or supernatural events. A fluid manipulator, such as a fan, a parachute, sail, or other sheet of material may be configured to interact with an airflow or a structural member (e.g., an airfoil) to facilitate shaping of the fluid. The fluid manipulator may be configured to actuate (e.g., translate, rotate, spin, swing) in a way that changes the shape of the fluid (e.g., by creating a wave or a bank). One or more sensors may detect a shape of a contour of the fluid and output data indicative of the shape of the contour of the fluid. For example, the sensors may detect when measured values (e.g., visibility, reflectivity, density, concentration, etc.) of the fluid cross one or more threshold values. The sensors may include, for example, computer vision systems, imaging sensors, infrared sensors, fluid level sensors, an array of lasers, and so forth. Further, multiple sensors may be disposed about the fluid to take measurements from the fluid from different vantage points. A controller (e.g., a processor-based computing device) may receive the data from the one or more sensors and map the shape of the contour of the fluid into three-dimensional space (e.g., by applying a mapping routine). This may include mapping an undulating surface (e.g., upper surface or boundary) of the fluid. The controller may then generate a command to actuate a ride vehicle and/or one or more set pieces to create the appearance that the ride vehicle and/or the one or more set pieces are floating in or on the surface of the fluid (e.g., on an undulating upper surface of the fluid). For example, the controller may generate a command to raise or lower the ride vehicle and/or the one or more set pieces based on the height of the contour of the fluid such that the ride vehicle and/or the one or more set pieces appear to be floating in or on the surface of the fluid. The controller may output the commands to one or more motion systems, which actuate the ride vehicle and/or the one or more set pieces based on the commands. In some embodiments, the one or more motion systems may be configured to actuate the ride vehicle and/or the one or more set pieces in a single vertical direction (e.g., raise and lower). In some embodiments, the one or more motion systems may be configured to translate the ride vehicle and/or the one or more set pieces in a horizontal plane (e.g., one or both horizontal directions). Further, in some embodiments, the one or more motion systems may be configured to rotate the ride vehicle and/or the one or more set pieces about one, two, or three axes (e.g., roll, pitch, and yaw), which may be used to create the appearance that the ride vehicle and/or the one or more set pieces are tilting in response to interaction with the fluid. As the shape of the contour of the fluid changes, the sensors may provide additional data to the controller, such that the controller generates new commands for the one or more motion systems to actuate the ride vehicle and/or the one or more set pieces in response to the changing shape of the contour of the fluid. Accordingly, presently disclosed embodiments may create the appearance that the ride vehicle and/or the one or more set pieces are interacting with the gaseous or liquid fluid. This may create a realistic experience for the guest, thus improving the guest experience and the guest's satisfaction. While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A ride system, comprising:
a fluid source configured to emit a fluid;
a sensor configured to detect a shape of a contour of the fluid and output data indicative of the shape of the contour of the fluid;
a computing device comprising:
processing circuitry; and
memory, accessible by the processing circuitry, the memory storing instructions that, when executed by the processing circuitry, are configured to cause the processing circuitry to perform operations comprising:
receiving, from the sensor, the data indicative of the shape of the contour of the fluid;
mapping the data indicative of the shape of the contour of the fluid into three-dimensional space; and
generating a command to raise or lower a ride vehicle based on the shape of the contour of the fluid in the three-dimensional space at a particular location; and
a motion system configured to:
receive the command from the computing device; and
raise or lower the ride vehicle based on the command.

2. The ride system of claim 1, wherein the operations comprise generating an additional command to adjust roll, pitch, or yaw of the ride vehicle based on the shape of the contour of the fluid in the three-dimensional space at the particular location, and wherein the motion system is configured to:
receive the additional command from the computing device; and
adjust the roll, the pitch, or the yaw of the ride vehicle based on the additional command.

3. The ride system of claim 1, wherein the operations comprise generating an additional command to raise or lower a set piece based on the shape of the contour of the fluid in the three-dimensional space at an additional particular location, wherein the ride system comprises an additional motion system, wherein the additional motion system is configured to raise or lower the set piece based on the additional command.

4. The ride system of claim 3, wherein the operations comprise generating a further command to adjust roll, pitch, or yaw of the set piece based on the shape of the contour of the fluid in the three-dimensional space at a further particular location, and wherein the additional motion system is configured to:
receive the further command from the computing device; and
adjust the roll, the pitch, or the yaw of the set piece based on the further command.

5. The ride system of claim 1, wherein the sensor comprises a computer vision sensor.

6. The ride system of claim 1, wherein the sensor comprises an imaging sensor.

7. The ride system of claim 1, wherein the sensor comprises an infrared sensor.

8. The ride system of claim 1, wherein the sensor comprises a fluid level sensor.

9. The ride system of claim 1, wherein the sensor comprises an array of lasers, wherein each laser in the array of lasers is configured to indicate whether the fluid is in its path.

10. The ride system of claim 1, comprising an additional sensor configured to detect the shape of the contour of the fluid and output additional data indicative of the shape of the contour of the fluid, relative to the additional sensor.

11. The ride system of claim 1, comprising wherein the particular location is a location where the ride vehicle and the fluid meet or overlap.

12. The ride system of claim 1, comprising a fluid manipulator configured to be actuated to form waves or banks in the fluid.

13. The ride system of claim 1, wherein the operations comprise:
receiving, from the sensor, additional data indicative of a new shape of the contour of the fluid;
mapping the additional data indicative of the new shape of the contour of the fluid into the three-dimensional space; and
generating an additional command to raise or lower the ride vehicle based on the new shape of the contour of the fluid in the three-dimensional space at the particular location.

14. A method of operating an amusement park ride, the method comprising:
emitting a fluid;
detecting a shape of a contour of the fluid;
mapping the shape of the contour of the fluid into three-dimensional space; and
raising or lowering an object based on the shape of the contour of the fluid in the three-dimensional space at a particular location, wherein the object comprises a ride vehicle or a set piece.

15. The method of claim 14, wherein mapping the location of the fluid into the three-dimensional space comprises executing a mapping routine stored in memory.

16. The method of claim 14, comprising manipulating the fluid to create a wave or a bank.

17. The method of claim 14, comprising:
detecting a new shape of the contour of the fluid;
mapping additional data indicative of the new shape of the contour of the fluid into the three-dimensional space; and
raising or lowering the object based on the new shape of the contour of the fluid in the three-dimensional space at the particular location.

18. A non-transitory computer readable medium storing instructions that, when executed by processing circuitry, cause the processing circuitry to perform operations comprising:
receiving, from a sensor, data indicative of a shape of a contour of a body of liquid or gaseous fluid;
mapping the data indicative of the shape of the contour of the body of fluid into three-dimensional space;
generating a set of coordinates for the body of fluid in the three-dimensional space;
generating a command to raise or lower a ride vehicle based on the shape of the contour of the body of fluid in the three-dimensional space at a particular location; and
outputting, to a motion system, the command.

19. The non-transitory computer readable medium of claim 18, wherein the operations comprise:
generating an additional command to adjust roll, pitch, or yaw of the ride vehicle based on the shape of the contour of the body of fluid in the three-dimensional space at the particular location; and
outputting the additional command to the motion system.

20. The non-transitory computer readable medium of claim 18, wherein the operations comprise:
generating an additional command to raise or lower a set piece based on the coordinates for the shape of the contour of the body of fluid in the three-dimensional space at an additional particular location; and
outputting the additional command to an additional motion system.
